(19) United States
(12) Patent Application Publication
(10) Pub. No.: US 2006/0188436 A1
(43) Pub. Date: Aug. 24, 2006

(54) Apparatus and method for the production of hydrogen

(76) Inventor: Linnard Griffin, Bertram, TX (US)

Correspondence Address: STORM L.L.P., BANK OF AMERICA PLAZA, 901 MAIN STREET, SUITE 7100, DALLAS, TX, 75202, US

(21) Appl. No.: 11/060,960

(22) Filed: Feb. 18, 2005

(51) Int. Cl. C01B 3/08

(52) U.S. Cl. 423/657; 205/637; 204/242

(57) ABSTRACT

Disclosed herein is an apparatus, mixture and method for the production of hydrogen comprising a solution with a pH less than 7, at least one colloidal metal suspended in the solution, and a second metal.

### TECHNICAL FIELD

The present invention is directed to a method and apparatus for the production of hydrogen gas from water.

### BACKGROUND

Hydrogen gas is a valuable commodity with many current and potential uses. Hydrogen gas may be produced by a chemical reaction between water and a metal or metallic compound. Very reactive metals react with mineral acids to produce a salt plus hydrogen gas. Equations 1 through 5 are examples of this process, where HX represents any mineral acid. HX can represent, for example HCl, HBr, HI, H₂SO₄, HNO₃, but includes all acids.
2Li+2HX→H₂+2LiX (1)
2K+2HX→H₂+2KX (2)
2Na+2HX→H₂+2NaX (3)
Ca+2HX→H₂+CaX₂ (4)
Mg+2HX→H₂+MgX₂ (5)

Each of these reactions take place at an extremely high rate due to the very high activity of lithium, potassium, sodium, calcium, and magnesium, which are listed in order of their respective reaction rates, with lithium reacting the fastest and magnesium reacting the most slowly of this group of metals. In fact, these reactions take place at such an accelerated rate that they have not been considered to provide a useful method for the synthesis of hydrogen gas in the prior art.

Metals of intermediate reactivity undergo the same reaction but at a much more controllable reaction rate. Equations 6 and 7 are examples, again where HX represents all mineral acids.
Zn+2HX→H₂+ZnX₂ (6)
2Al+6HX→3H₂+2AlX₃ (7)

Reactions of this type provide a better method for the production of hydrogen gas due to their relatively slower and therefore more controllable reaction rate. Metals like these have not, however, been used in prior art production of diatomic hydrogen because of the expense of these metals.

Iron reacts with mineral acids by either of the following equations:
Fe+2HX→H₂+FeX₂ (8)
or
2Fe+6HX→3H₂+2FeX₃ (9)

Due to the rather low activity of iron, both of these reactions take place at a rather slow reaction rate. The reaction rates are so slow that these reactions have not been considered to provide a useful method for the production of diatomic hydrogen in the prior art. Thus, while iron does provide the availability and low price needed for the production of elemental hydrogen, it does not react at a rate great enough to make it useful for hydrogen production.

Metals such as silver, gold, and platinum are not found to undergo reaction with mineral acids under normal conditions in the prior art.
Ag+HX→No Reaction (10)
Au+HX→No Reaction (11)
Pt+HX→No Reaction (12)

Accordingly, a need exists for a method and apparatus for the efficient production of hydrogen gas using relatively inexpensive metals.

### SUMMARY

It is a general object of the disclosed invention to provide a method and apparatus for the production of hydrogen gas. This and other objects of the present invention are achieved by providing a method, mixture and apparatus:

An apparatus for the production of hydrogen, comprising a reaction medium with a pH less than 7; a first metal, wherein the first metal is a colloidal metal suspended in the reaction medium; and a second metal, wherein the second metal is in contact with the reaction medium.

According to one preferred embodiment of the present invention, the second metal is in solid, non-colloidal form

According to another embodiment, the first metal is less reactive than the second metal.

According to another embodiment, the apparatus comprises a third metal in contact with the reaction medium.

According to another embodiment, the third metal is in colloidal form.

According to another embodiment, the third metal is more reactive than the second metal.

According to another embodiment, the apparatus comprises a reaction vessel for containing the reaction medium, wherein the reaction vessel is inert to the reaction medium.

According to another embodiment, the reaction vessel is configured to maintain an internal pressure above atmospheric pressure.

According to another embodiment, the first metal is silver, gold, platinum, tin, lead, copper, zinc, iron, aluminum, magnesium, beryllium, nickel or cadmium.

According to another embodiment, the second metal is iron, aluminum, magnesium, beryllium, tin, lead, nickel or copper.

According to another embodiment, the third metal is aluminum, magnesium, beryllium or lithium.

According to another embodiment, the reaction medium comprises hydrogen peroxide.

According to another embodiment, the reaction medium comprises formic acid.

According to another embodiment, the apparatus comprises an elemental nonmetal in contact with the reaction medium.

According to another embodiment, the apparatus comprises an energy source.

According to another embodiment, the energy source is a heater.

According to another embodiment, the energy source is a light source.

According to another embodiment, the energy source is an electrical potential applied to the reaction medium.

According to another embodiment, the apparatus comprises an anode and a cathode, wherein the anode and cathode are in contact with the reaction medium and wherein an electrical potential is applied between the anode and cathode.

According to another embodiment, the apparatus comprises third and fourth metals, wherein at least one of the second, third or fourth metals is in colloidal form.

### BRIEF DESCRIPTION OF THE DRAWINGS

FIG. 1 is a diagram of a reactor for the production of hydrogen; and

FIG. 2 is a diagram of a laboratory experimental setup.

### DETAILED DESCRIPTION

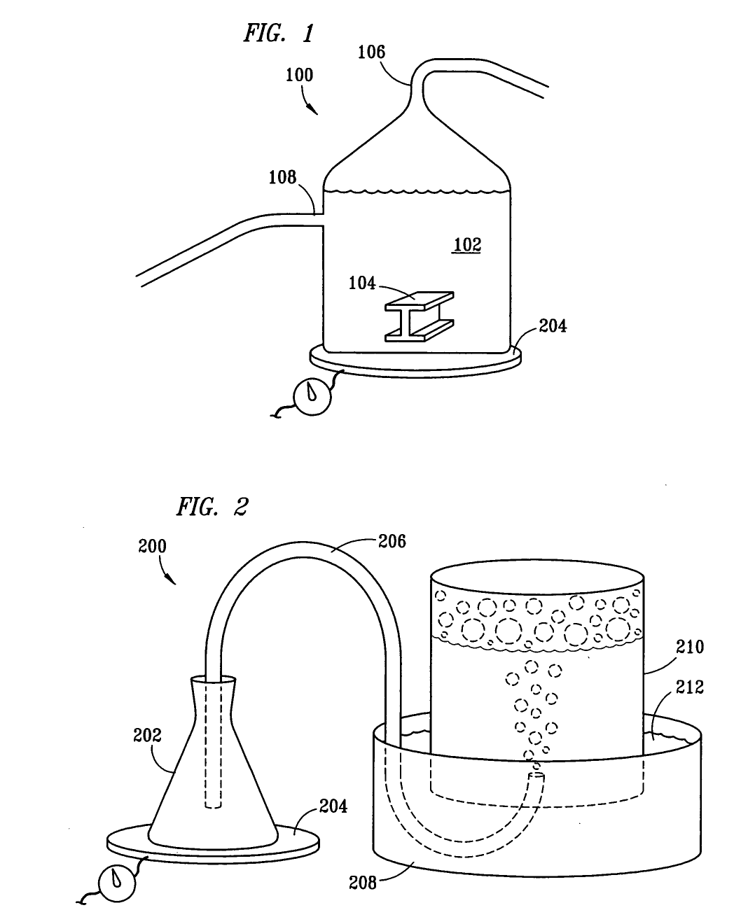

FIG. 1 shows a mixture and apparatus that may be used for the production of hydrogen. A reaction vessel 100 contains a reaction medium 102. The reaction medium preferably comprises water and an acid, and preferably has a pH less than 5, although other reaction media may be used including other solvents or non-liquid media such as gelatinous or gaseous media. The acid is preferably sulfuric acid with a variable concentration up to 98% by weight or hydrochloric acid with a variable concentration up to 35% by weight, although other acids may be used. The reaction vessel 100 is inert to the reaction medium 102. The reaction medium 102 contains a first colloidal metal (not shown) suspended in the solution. The first colloidal metal is preferably a metal with low activity such as silver, gold, platinum, tin, lead, copper, zinc or cadmium, although other metals may be used.

The reaction vessel 100 also preferably contains a second metal 104, at least partially submerged in the reaction medium 102. The second metal 104 may be in any form but is preferably in the form of a solid with a relatively large surface area, such as pellet form. The second metal 104 is preferably a metal with a mid-range activity, such as iron, aluminum, zinc, nickel or tin. The second metal 104 preferably has a higher activity than the first colloidal metal. The second metal 104 is most preferably iron, because of its medium reactivity and low cost. Preferably, the reaction medium 102 also contains a second colloidal metal (not shown). The second colloidal metal preferably has a higher activity than the second metal 104, such as aluminum, magnesium, beryllium, and lithium. Preferably, the reaction vessel 100 also contains another metal (not shown), which is a different metal than the second metal 104, but which is in the same general form. Therefore, in the most preferable case, the reaction vessel 100 contains two metals in solid form in contact with the reaction medium 102, as well as two colloidal metals suspended in the reaction medium 102.

Alternatively to the above, the reaction medium 102 may contain a metal salt or metal oxide, rather than an acid and the second metal 104, in addition to the one or more colloidal metals. Preferably, the reaction medium 102 contains a solid metal and either an acid or a metal salt or metal oxide of the same metal as the solid metal. It is believed that if the reaction medium 102 initially contains a solid metal and a strong acid, such as HCl or H₂SO₄, the acid reacts with the solid metal, creating metal ions and releasing hydrogen gas, until the acid or solid metal is substantially consumed. It is also believed that a solution initially containing a metal salt along with a proper colloidal catalyst will become acidic, even if the initial pH is greater than 7. Additionally, the apparatus may comprise a combination of metal salts, oxides and solid metals, in addition to one or more colloidal metal.

The reaction vessel 100 has an outlet 106 to allow hydrogen gas (not shown) to escape. The reaction vessel may also have an inlet 108 for adding water or other constituents to maintain the proper concentrations. The reaction vessel may also include one or more anode (not shown) and one or more cathode (not shown) which contact the reaction medium. The anodes and cathodes may be used to provide electrical energy to the reaction or to utilize electrical energy created by the reactions for other purposes.

Because the reactions expected to occur in the reaction vessel are believed to be collectively endothermic, an energy source 112 is also preferably provided to increase the rate of reaction, although the reaction may potentially be powered by ambient heat. While the energy source shown in FIG. 1 is a heater (hot plate), other forms of energy may be used including electric and light energy. There may be other effects of light or other electromagnetic radiation, in addition to the energy effect. Additionally, the reaction temperature is limited to about 100° C. at atmospheric pressure where an aqueous solution is used as the reaction medium or boiling may occur (neglecting changes in the boiling point due to the addition of solutes). Therefore, it may be advantageous to perform the reactions in a reaction vessel 100 which is configured to maintain an internal pressure above atmospheric pressure so that higher reaction temperatures may be used.

Most metals can be produced in a colloidal state in an aqueous solution. A colloid is a material composed of very small particles of one substance that are dispersed (suspended), but not dissolved in solution. Thus colloidal particles do not settle out of solution even though they exist in the solid state. A colloid of any particular metal is then a very small particle of that metal suspended in a solution. These suspended particles of metal may exist in the solid (metallic) form or in the ionic form, or as a mixture of the two. The very small size of the particles of these metals results in a very large effective surface area for the metal. This very large effective surface area for the metal can cause the surface reactions of the metal to increase dramatically when it comes into contact with other atoms or molecules. The colloidal metals used in the experiments described below were obtained using a colloidal silver machine sold by CS Prosystems of San Antonio, Tex. The website of CS Prosystems is www.csprosystems.com. Colloidal solutions of metals that are produced using this apparatus result from an electrolytic process and are thought to contain colloidal particles some of which are electrically neutral and some of which are positively charged. Other methods can be employed in the production of colloidal metal solutions where all of the colloidal particles are thought to be electrically neutral. It is believed that the positive charge on the colloidal metal particles used in the experiments described below provides additional rate enhancement effects. It is still believed however that it is to a great extent the size and the resulting surface area of the colloidal particles that causes a significant portion of the rate enhancement effects that are detailed below, regardless of the charge on the colloidal particles. Based on materials from the manufacturer, the particles of a metal in the colloidal solutions used in the experiments described below are believed to range in size between 0.001 and 0.01 microns. In such a solution of colloidal metals, the concentration of the metals is believed to be between about 5 to 20 parts per million.

Alternative to using a catalyst in colloidal form, it may be possible to use a catalyst in another form that offers a high surface-area to volume ratio, such as a porous solid, nanometals, colloid-polymer nanocomposites and the like. In general, any catalysts may be in any form with an effective surface area of at least 298,000,000 m² per cubic meter of catalyst metal, although smaller surface area ratios may also work.

Thus when any metal, regardless of its normal reactivity, is used in its colloidal form, the reaction of the metal with mineral acids can take place at an accelerated rate. Equations 13-15 are thus general equations that are believed to occur for any metals in spite of their normal reactivity, where M represents any metal. M, for instance, can represent, but is not limited to, silver, copper, tin, zinc, lead, and cadmium. In fact, it has been found that the reactions shown in equations 13-15 occur at a significant reaction rate even in solutions of 1% aqueous acid.
2M+2HX→2MX+H₂ (13)
M+2HX→MX₂+H₂ (14)
2M+6HX→2MX₃+3H₂ (15)

Even though equations 13-15 represent largely endothermic processes for a great many metals, particularly those of traditional low reactivity (for example, but not limited to, silver, gold, copper, tin, lead, and zinc), the rate of the reactions depicted in equations 13-15 is in fact very large due to the surface effects caused by the use of the colloidal metal. While reactions involved with equations 13-15 take place at a highly accelerated reaction rate, these reactions do not result in a useful production of elemental hydrogen since the colloidal metal by definition is present in very low concentrations.

A useful preparation of hydrogen results, however, by the inclusion of a metal more reactive than the colloidal metal such as, but not limited to, metallic iron, metallic aluminum, or metallic nickel. Thus any colloidal metal in its ionic form would be expected to react with the metal Me as indicated in equation 16, where those metals below Me on the electromotive or activity series of metals would react best.
Mₑ+M⁺→M+Mₑ⁺ (16)

It is believed that the reaction illustrated by equation 16 in fact takes place quite readily due to the large effective surface area of the colloidal ion, M⁺, and also due to the greater reactivity of the metal Mₑ compared to any metal of lower reactivity which would be of preferable use. In fact, for metals normally lower in reactivity than Mₑ, equation 16 would result in a highly exothermic reaction. The resulting metal, M, would be present in colloidal quantities and thus, it is believed, undergoes a facile reaction with any mineral acid including, but not limited to, sulfuric acid, hydrochloric acid, hydrobromic acid, nitric acid, hydroiodic acid, perchloric acid, and chloric acid. However, the mineral acid is preferably sulfuric acid, H₂SO₄, or hydrochloric acid, HCl. Equation 17 describes this reaction where the formula HX (or H⁺+X⁻ in its ionic form) is a general representation for any mineral acid.
2M+2H⁺+2X⁻→2M⁺+H₂+2X⁻ (17)

While equation 17 represents an endothermic reaction, it is believed the exothermicity of the reactions in equation 16 compensates for this, making the combination of the two reactions energetically obtainable using the thermal energy supplied by ambient conditions. Of course the supply of additional energy would accelerate the process.

Consequently, it is believed that elemental hydrogen is efficiently and easily produced by the combination of the reactions shown in equations 18 and 19.
4Mₑ+4M⁺→4M+4Mₑ⁺ (18)
4M+4H⁺+4X⁻→4M⁺+2H₂+4X⁻ (19)

Thus the metal Mₑ reacts with the colloidal metal ion in equation 18 to produce a colloidal metal and the ionic form of Mₑ. The colloidal metal will then react with a mineral acid in equation 19 to produce elemental hydrogen and regenerate the colloidal metal ion. The colloidal metal ion will then react again by equation 18, followed again by equation 19, and so on in a chain reaction process to provide an efficient source of elemental hydrogen. In principle, any colloidal metal ion should undergo this process successfully. It is found that the reactions work most efficiently when the colloidal metal ion is lower in reactivity than the metal Mₑ on the electromotive series table. The combining of equations 18 and 19 results in the net equation 20. Equation 20 has as its result the production of elemental hydrogen from the reaction of the metal Mₑ and a mineral acid.
4 Mₑ+4M⁺→4M+4Me⁺ (18)
+
4M+4H⁺+4X⁻→4M⁺+2H₂+4X⁻ (19)
=
4 Mₑ+4H⁺→4 Mₑ⁺+2H₂ (20)

Equation 20 summarizes a process that provides a very efficient production of elemental hydrogen where the metal Mₑ and acid are consumed. It is believed, however, that both the elemental metal Mₑ and the acid are regenerated as a result of a voltaic electrochemical process or thermal process that follows. It is believed that a colloidal metal Mᵣ (which can be the same one used in equation 18 or a different one) can undergo a voltaic oxidation-reduction reaction indicated by equations 21 and 22.
Cathode (reduction)
   4Mᵣ⁺+4e⁻→4Mᵣ (21)
Anode (oxidation)
   2H₂O→4H⁺+O₂+4e⁻ (22)

The colloidal metal Mᵣ can in principle be any metal, but reaction 21 progresses most efficiently when the metal has a higher (more positive) reduction potential. Thus, the reduction of the colloidal metal ion, as indicated in equation 21, takes place most efficiently when the colloidal metal is lower than the metal Me on the electromotive series of metals. Consequently, any colloidal metal will be successful, but reaction 21 works best with colloidal metals such as colloidal silver or lead, due to the high reduction potential of these metals. When lead, for example, is employed as the colloidal metal ion in equations 21 and 22, the pair of reactions is found to take place quite readily. The voltaic reaction produces a positive voltage as the oxidation and reduction reactions indicated take place. This positive voltage can be used to supply the energy required for other chemical processes. In fact, the voltage produced can even be used to supply an over potential for reactions employing equations 21 and 22 taking place in another reaction vessel. Thus, this electrochemical process can be made to take place more quickly without the supply of an external source of energy. The resulting colloidal metal, Mᵣ, can then react with oxidized ionic metal, Mₑ, as indicated in equation 23 which would result in the regeneration of the metal, Mₑ, and the regeneration of the colloidal metal in its oxidized form.
4 Mₑ⁺+4Mᵣ→4Mᵣ⁺+4Mₑ (23)

The reaction described by equation 23 could in fact occur using as starting material any colloidal metal, but will take place most effectively when the colloidal metal, Mᵣ, appears above the metal, Mₑ, on the electromotive series. The combining of equations 21-23 results in equation 24 which represents the regeneration of the elemental metal, Mₑ, the regeneration of the acid, and the formation of elemental oxygen.
4Mᵣ⁺+4e⁻→4Mᵣ (21)
+
2H₂O→4H⁺+O₂+4e⁻ (22)
+
4Mₑ⁺+4Mᵣ→4Mᵣ⁺+4Mₑ (23)
=
4Mₑ⁺+2H₂O→4H⁺+4Mₑ+O₂ (24)

The reaction shown in equations 21 and 22 seems to occur best when the colloidal metal, Mᵣ, is as low as possible on the electromotive series of metals; however, the reaction depicted by equation 23 takes place most efficiently when the colloidal metal, Mᵣ, is as high as possible on the electromotive series of metals. The net reaction illustrated by equation 24, which is merely the sum of equations 21, 22, and 23, could in fact be maximally facilitated by either colloidal metals of higher activity or by colloidal metals of low activity. The relative importance of the reaction illustrated by equations 21 and 22 compared to the reaction shown in equation 23 would determine the characteristics of the colloidal metal that would best assist the net reaction in equation 24. It has been found that the net reaction indicated in equation 24 proceeds at a maximal rate when the colloidal metal is of maximum activity, that is, when the colloidal metal is as high as possible on the electromotive series of metals. It has been found that the more reactive colloidal metals such as, but not limited to, colloidal magnesium ion or colloidal aluminum ion produce the most facile processes for the reduction of cationic metals.

The combination of equations 20 and 24 results in a net process indicated in equation 25. As discussed above, the reaction depicted in equation 21 proceeds most efficiently when the colloidal metal is found below the metal, Mₑ, on the electromotive series. However, the reaction represented by equation 23 is most favorable when the colloidal metal is found above the metal, Mₑ, on the electromotive series. Accordingly, it has been observed that the concurrent use of two colloidal metals, one above the metal, Mₑ, and one below it in the electromotive series, for example, but not limited to, colloidal lead and colloidal aluminum, produces optimum results in terms of the efficiency of the net process. Since equation 25 merely depicts the decomposition of water into elemental hydrogen and elemental oxygen, the complete process for the production of elemental hydrogen now has only water as an expendable substance, and the only necessary energy source is supplied by ambient thermal conditions.
4Mₑ+4H⁺→4Mₑ⁺+2H₂ (20)
4 Mₑ⁺+2H₂O→4H⁺+4Mₑ+O₂ (24)
2H₂O→2H₂+O₂ (25)

The net result of this process is exactly that which would result from the electrolysis of water. Here, however, no electrical energy needs to be supplied. Although the providing of additional energy would result in an enhanced rate of hydrogen formation, the reaction proceeds efficiently when the only energy supplied is ambient thermal energy. When additional energy is supplied, it can be supplied in the manner of thermal energy, electrical energy or as radiant energy. As discussed above, when the additional energy supplied is in the form of thermal energy, it may be preferable to use a reaction vessel 100 configured to maintain internal pressures greater than the prevailing atmospheric pressure in order increase the boiling point of the solution, and increase the amount of thermal energy that can be supplied. The colloidal metallic ion catalysts, as well as the metal Mₑ, and the acid are regenerated in the process, leaving only water as a consumable material.

A further means by which the rate of hydrogen production could be increased would involve the inclusion of a nonmetal in the reaction such as, but not limited to, carbon or sulfur. Using the symbol Z to represent the nonmetal, equation 22 would be replaced by equation 22A which would provide a more facile reaction due to the thermodynamic stability of the oxide of the nonmetal.
2H₂O+Z→4H⁺+ZO₂+4e⁻ (22A)
Equation 24 would then be replaced by equation 24A, and equation 25 would be replaced by equation 25A.
4Mₑ⁺+2H₂O+Z→4H⁺+4Mₑ+ZO₂ (24A)
2H₂O+Z→2H₂+ZO₂ (25A)
Thus, rather than resulting in the formation of elemental oxygen, the reaction would produce an oxide of a nonmetal such as CO₂ or SO₂, where the thermodynamic stability of the nonmetal oxide would provide an additional driving force for the reaction, and thus result in an even faster rate of hydrogen production.

An alternative to this process involves the introduction of hydrogen peroxide to react in the place of water. Thus, the reactions illustrated in equations 22 and 23 would be replaced by similar reactions illustrated by equations 26 and 27. The net result of these two reactions would be the reaction represented in equation 28, the production of elemental hydrogen using an elemental metal Me and a mineral acid as reactants.
2Mₑ+2M⁺→2M+2Me⁺ (26)
+
2M+2H⁺+2X⁻→2M⁺¹+H₂+2X⁻ (27)
=
2Mₑ+2H⁺→2Mₑ⁺+H₂ (28)

The elemental metal, Mₑ, as well as the mineral acid, would then be regenerated as a result of a different voltaic electrochemical process followed by a thermal reaction. Again a colloidal metal, Mᵣ, reacts with hydrogen peroxide in an oxidation-reduction reaction indicated by equations 29 and 30.
Cathode (reduction)
   2Mᵣ⁺+2e⁻→2Mᵣ(29)
Anode (oxidation)
   H₂O₂→2H⁺+O₂+2e⁻ (30)

Due to the fact that hydrogen peroxide has a larger (less negative) oxidation potential than water, as shown in the standard oxidation potentials listed below, the oxidation-reduction reaction resulting from equations 29 and 30 takes place at an enhanced rate compared to the oxidation-reduction reaction indicated by equations 21 and 22.
2H₂O→4H⁺+O₂+4e⁻ ε⁰ oxidation=−1.229V
H₂O₂→2H⁺+O₂+2e⁻ ε⁰ oxidation=−0.695V

The colloidal metal can in principle be any metal but works most efficiently when the metal has a higher (more positive) reduction potential. Thus, the regeneration process takes place most efficiently when the colloidal metal is as low as possible on the electromotive series of metals. Consequently, any colloidal metal will be successful, but the reaction works well with colloidal silver ion, for example, due to the high reduction potential of silver. When silver is employed as the colloidal metal ion in equations 29 and 30, the pair of reactions is found to take place quite readily. The voltaic reaction produces a positive voltage as the oxidation and reduction reactions indicated take place. This positive voltage can be used to supply the energy required for other chemical processes. In fact, the voltage produced can even be used to supply an over potential for reactions employing equations 29 and 30 taking place in another reaction vessel. Thus, this electrochemical process can be made to take place more quickly without the supply of an external source of energy. The resulting colloidal metal, Mᵣ, will then react to regenerate the metal, Me (equation 31).
2Mₑ⁺+2Mᵣ→2Mᵣ⁺+2Mₑ (31)

The reaction illustrated by equation 31 will take place most efficiently when the colloidal metal, Mᵣ, is more reactive than the metal, Mₑ. That is, the reaction in equation 31 will proceed most efficiently when the colloidal metal, Mᵣ, is above the metal, Mₑ, on the electromotive series of metals. The combining of equations 29-31 results in equation 32 which represents the regeneration of the elemental metal, Mₑ, the regeneration of the acid, and the formation of elemental oxygen.
2Mᵣ⁺+2e⁻→2Mᵣ (29)
+
H₂O₂→2H⁺+O₂+2e⁻ (30)
+
2Mₑ⁺+2Mᵣ→2Mᵣ⁺+2Mₑ (31)
=
2Mₑ⁺+H₂O₂→2H⁺+2Mₑ⁺O₂ (32)

The reaction shown in equations 29 and 30 seems to occur best when the colloidal metal, Mᵣ, is as low as possible on the electromotive series of metals; however, the reaction depicted by equation 31 takes place most efficiently when the colloidal metal, Mᵣ, is as high as possible on the electromotive series of metals. The net reaction illustrated by equation 32, which is merely the sum of equations 29, 30, and 31, could in fact be maximally facilitated by either colloidal metals of higher activity, or by colloidal metals of lower activity. The relative importance of the reaction illustrated by equations 29 and 30 compared to the reaction shown in equation 31 would determine the characteristics of the colloidal metal that would best assist the net reaction in equation 32. It has been found that the net reaction indicated in equation 32 proceeds at a maximal rate when the colloidal metal is of maximum activity, that is, when the colloidal metal is as high as possible on the electromotive series of metals. It has been found that the more reactive colloidal metals such as, but not limited to, colloidal magnesium ion, and colloidal aluminum ion produce the most facile reduction processes for the reduction of cationic metals.

The combination of equations 28 and 32 results in a. net process indicated in equation 33. Since equation 33 merely depicts the decomposition of hydrogen peroxide into elemental hydrogen and elemental oxygen, the complete process for the production of elemental hydrogen now has only hydrogen peroxide as an expendable substance, and the only necessary energy source is supplied by ambient thermal conditions. Although the providing of additional energy would result in an enhanced rate of hydrogen formation, the reaction proceeds efficiently when the only energy supplied is ambient thermal energy. When additional energy is supplied, it can be supplied in the manner of thermal energy, electrical energy or as radiant energy. When the additional energy supplied is in the form of thermal energy, one is limited by the boiling point of the solvent. In aqueous systems this would provide a maximum temperature of 100° C. Under pressures higher than one atmosphere, however, temperatures higher than 100° C. could be obtained, and would provide an even more enhanced rate of hydrogen production.
2Mₑ+2H⁺→2Mₑ⁺+H₂ (28)
+
2Mₑ⁺+H₂O₂→2H⁺+2M_{e+O}₂ (32)
=
H₂O₂→H₂+O₂ (33)

Since the regeneration of the metal, Mₑ, and the mineral acid are significantly lower with respect to reaction rate than the oxidation of the metal, Mₑ, by a mineral acid, it is the regeneration of the metal, Mₑ, and the mineral acid that proves to be rate determining in this process. Since the oxidation of hydrogen peroxide (equation 30) is more favorable than the oxidation of water (equation 22), the rate of hydrogen formation is significantly enhanced when hydrogen peroxide is used in the place of water. This, of course, must be balanced by the fact that hydrogen peroxide is obviously a more costly reagent to supply, and that the ratio of elemental hydrogen to elemental oxygen becomes one part hydrogen to one part oxygen as indicated in equation 33. This would differ from the ratio of two parts hydrogen to one part oxygen as found in equation 25, where water is oxidized. In cases where the rate of hydrogen production is the most critical factor, the use of hydrogen peroxide will offer a significant advantage.

A further means by which the rate of hydrogen production could be increased would involve the inclusion of a nonmetal in the reaction such as, but not limited to, carbon or sulfur. Using the symbol Z to represent the nonmetal, equation 30 would be replaced by equation 30A which would provide a more facile reaction due to the thermodynamic stability of the oxide of the nonmetal.
H₂O₂+Z→2H⁺+ZO₂+2e⁻ (30A)
Equation 32 would then be replaced by equation 32A, and equation 33 would be replaced by equation 33A.
2Mₑ⁺+H₂O₂+Z→2H⁺+2Mₑ+ZO₂ (32A)
H₂O₂+Z→H₂+ZO₂ (33A)

Thus, rather than resulting in the formation of elemental oxygen, the reaction would produce an oxide of a nonmetal such as CO₂ or SO₂, where the thermodynamic stability of the nonmetal oxide would provide an additional driving force for the reaction, and thus result in an even faster rate of hydrogen production. A further alternative to this process involves the introduction of formic acid to react in the place of water, or hydrogen peroxide. Thus, the reactions illustrated in equations 22 and 23 would be replaced by similar reactions illustrated by equations 26 and 27. The net result of these two reactions would be the reaction represented in equation 28, the production of elemental hydrogen using an elemental metal, Mₑ, and a mineral acid as reactants.
2Mₑ+2M⁺→2M+2Mₑ⁺ (26)
+
2M+2H⁺+2X⁻→2M⁺¹+H₂+2X⁻ (27)
=
2Mₑ+2H⁺→2Me⁺+H₂ (28)

The elemental Metal, Mₑ, as well as the mineral acid would then be regenerated as a result of a different voltaic electrochemical process followed by a thermal reaction. In this case, however, the colloidal metal, Mᵣ, reacts with formic acid in an oxidation-reduction reaction indicated by equations 29 and 34.
Cathode (reduction)
   2Mᵣ⁺+2e⁻2Mᵣ (29)
Anode (oxidation)
   CH₂O₂→2H⁺+CO₂+2e⁻ (34)

Due to the fact that formic acid has a very favorable positive oxidation potential compared to the negative ones reported for water and for hydrogen peroxide, as shown by the standard oxidation potentials listed below, the oxidation-reduction reaction resulting from equations 29 and 34 takes place at an enhanced rate compared to the oxidation-reduction reaction indicated by equations 21 and 22, or the oxidation-reduction reaction indicated by equations 29 and 30.
2H₂O→4H⁺+O₂+4e⁻ ε⁰oxidation=−1.229V
H₂O₂→2H⁺+O₂+2e⁻ ε⁰oxidation=−0.695V
CH₂O₂→2H⁺+CO₂+2e⁻ ε⁰oxidation=0.199V

The colloidal metal can in principle be any metal but works most efficiently when the metal has a higher (more positive) reduction potential. Thus, the regeneration process takes place most efficiently when the colloidal metal is as low as possible on the electromotive series of metals. Consequently, any colloidal metal will be successful, but the reaction works well with colloidal silver ion, for example, due to the high reduction potential of silver. When silver is employed as the colloidal metal ion in equations 29 and 34, the pair of reactions is found to take place quite readily. The voltaic reaction produces a positive voltage as the oxidation and reduction reactions indicated take place. This positive voltage can be used to supply the energy required for other chemical processes. In fact, the voltage produced can even be used to supply an over potential for reactions employing equations 29 and 34 taking place in another reaction vessel. Thus, this electrochemical process can be made to take place more quickly without the supply of an external source of energy. The resulting colloidal metal, Mᵣ, will then react to regenerate the metal, Mₑ (equation 31).
2Mₑ⁺+2Mᵣ→2Mᵣ⁺+2Mₑ (31)

The reaction illustrated by equation 31 will take place most efficiently when the colloidal metal, Mᵣ, is more reactive than the metal, Mₑ. That is, the reaction in equation 31 will proceed most efficiently when the colloidal metal, Mᵣ, is above the metal, Mₑ, on the electromotive series of metals. The combining of equations 29, 34 and 31 produces the net reaction shown by equation 35. The net reaction represented by equation 35 results in the regeneration of the elemental metal, Mₑ, the regeneration of the acid, and the formation of carbon dioxide.
2Mᵣ⁺+2e⁻→2Mᵣ (29)
+
CH₂O₂→2H⁺+CO₂+2e⁻ (34)
+
2Mₑ⁺+2Mᵣ→2Mᵣ⁺+2Mₑ (31)
=
2Mₑ⁺+CH₂O₂→2H⁺+2Mₑ+CO₂ (35)

The reaction shown in equations 29 and 34 seems to occur best when the colloidal metal, Mᵣ, is as low as possible on the electromotive series of metals; however, the reaction depicted by equation 31 takes place most efficiently when the colloidal metal, Mᵣ, is as high as possible on the electromotive series of metals. The net reaction illustrated by equation 35, which is merely the sum of equations 29, 34, and 31, could, in fact, be maximally facilitated by either colloidal metals of higher activity or by colloidal metals of lower activity. The relative importance of the reaction illustrated by equations 29 and 34 compared to the reaction shown in equation 31 would determine the characteristics of the colloidal metal that would best assist the net reaction in equation 35. It has been found that the net reaction indicated in equation 35 proceeds at a maximal rate when the colloidal metal is of maximum activity, that is, when the colloidal metal is as high as possible on the electromotive series of metals. It has been found that the more reactive colloidal metals such as, but not limited to, colloidal magnesium ion and colloidal aluminum ion, produce the most facile reduction processes for the reduction of the cationic metals.

The combination of equations 28 and 35 results in a net process indicated in equation 36. Since equation 33 merely depicts the decomposition of formic acid into elemental hydrogen and carbon dioxide, the complete process for the production of elemental hydrogen now has only formic acid as an expendable substance, and the only necessary energy source is supplied by ambient thermal conditions. Although the providing of additional energy would result in an enhanced rate of hydrogen formation, the reaction proceeds efficiently when the only energy supplied is ambient thermal energy. When additional energy is supplied, it can be supplied in the manner of thermal energy, electrical energy or as radiant energy. When the additional energy supplied is in the form of thermal energy, one is limited by the boiling point of the solvent. In aqueous systems, this would provide a maximum temperature of 100° C. Under pressures higher than one atmosphere, however, temperatures higher than 100° C. could be obtained and would provide an even more enhanced rate of hydrogen production.
2Mₑ+2H⁺→2Mₑ⁺+H₂ (28)
+
2Mₑ⁺+CH₂O₂→2H⁺+2Mₑ+CO₂ (35)
=
CH₂O₂→H₂+CO₂ (36)

Since the regeneration of the metal, Mₑ, and the mineral acid are significantly lower with respect to reaction rate than the oxidation of the metal, Mₑ, by a mineral acid, it is the regeneration of the metal, Mₑ, and the mineral acid that proves to be rate determining in this process. Since the oxidation of formic acid (equation 34) is more favorable than the oxidation of water (equation 22), or the oxidation of hydrogen peroxide (equation 30), the rate of hydrogen formation is significantly enhanced when formic acid is used in the place of water or in the place of hydrogen peroxide. This, of course, must be balanced by the facts that formic acid is a more costly reagent than water, but a less costly one than hydrogen peroxide, and that the co-product formed along with hydrogen is carbon dioxide rather than oxygen. Additionally, the ratio of elemental hydrogen to carbon dioxide is one part hydrogen to one part carbon dioxide, as indicated in equation 36. This would differ from the ratio of two parts hydrogen to one part oxygen, as found in equation 25, where water is oxidized. In cases, however, where the rate of hydrogen production is the most critical factor, the use of formic acid will offer a significant advantage.

Finally, while all equations depicted here involve the use of just a single metal, Mₑ, in addition to the colloidal metal(s), it has been shown that all of the reactions discussed herein can be carried out using a combination of two or more different metals in the place of the single metal, Mₑ, along with one or more colloidal metal(s). It has been shown, in fact, that in some cases the use of multiple metals results in a significant rate enhancement over a rather large period of time. In experiments #7 and #10, for example, a mixture of metallic iron and metallic aluminum is used. The steady state production of hydrogen that results from experiment #10, for example, is approximately 100 mL of hydrogen per minute with the total volume of the reaction vessel being just over 100 mL. In experiments #8 and #9, similar reactions are carried out with just a single metal, aluminum, and it is demonstrated that when the reaction rate decreases, the addition of the second metal, iron, results in an immediate rate increase to a rate similar to those reactions where the two metals were present throughout the reaction. It is not clear at this point what causes this impressive rate enhancement. It is possible that the multiple metals all take part in the reaction mechanism to provide a more complicated mechanism having a greater number of steps, but a lower net activation barrier. Another possibility is that a second metal might provide a surface where the regenerated metal, Mₑ, could reform more efficiently. Whatever the explanation, experiments #9 and #10 very clearly demonstrate that the rate enhancement caused by the use of two different metals is quite obvious and quite significant.

Experimental Results:

Experiment #1 Summary:

An initial solution comprising 10 mL of 93% concentration H₂SO₄ and 30 mL of 35% concentration HCl was reacted with iron pellets (sponge iron) and about 50 mL of colloidal magnesium and 80 mL of colloidal lead each at a concentration believed to be about 20 ppm. A theoretical maximum of 8.06 liters of hydrogen gas could be produced if solely from the consumption of the acids as indicated in Table 1.

TABLE 1
Starting Solution Maximum H₂ Yield with Acid Consumption

| | | | | Effective | |
|---|---|---|---|---|---|
| | | | Total | Grams of | Maximum H₂ |
| Acid | mL | Concentration | Grams | Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole H₂ (22.4 liters)
1 mole H₂SO₄ = 98 grams

Therefore, the maximum yield is 0.23 liters of H₂ per gram of H₂SO₄.

2 moles of HCl yields 1 mole H₂ (22.4 liters)

2 moles of HCl=73 grams

Therefore, a theoretical maximum yield of 0.31 liters of H₂ per gram of HCl is expected without the regeneration reaction.

The experimental setup was as illustrated in FIG. 2. The acid and iron solution was placed in flask 202. A hot plate 204 was used to provide thermal energy for the reaction and maintain the solution at a temperature of about 71° C. The gas produced by the reaction was fed through tube 206 to a volume-measuring apparatus 208. The volume-measuring apparatus 208 was an inverted reaction vessel 210 filled with water and placed in a water bath 212. The primary purpose of the experiment was to provide evidence that more than the theoretical maximum 8.06 liters of hydrogen was being produced by the closed-loop process of the invention.

The rate of the reaction initially is very fast with hydrogen generation at ambient temperature. When the acids are temporally consumed, the regeneration process takes into effect and the reaction rate slows. Heat may be added to the process to accelerate the regeneration process.

At least 15 liters of gas was observed to have been produced, and the reaction was still proceeding in a continuous fashion (about 2 bubbles of gas per second at 71° C.) when interrupted. It should be noted that the 15 liters of gas observed does not account for hydrogen gas losses likely due to leakage. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides ample evidence of the regeneration process.

A follow-up experiment was conducted using iron (III) chloride (FeCl₃) as the only source of iron in an attempt to qualitatively verify the reverse reaction. Pure iron (III) chloride was chosen because it could be shown to be free of iron in any other oxidation state. While similar experiments had been successfully carried out using iron (III) oxide as the source of iron, the results were clouded by the fact that other oxidation states of iron may have been present. The results are described in Experiment #2, below.

Experiment #2 Summary:

An experiment was conducted using 150 mL of iron (III) chloride in an aqueous solution (commonly used as an etching solution, purchased from Radio Shack) as the starting materials. Ten mL of 93% concentration sulfuric acid (H₂SO₄) was added to the solution, at which point no reaction occurred. About 50 mL of colloidal magnesium and 80 mL of colloidal lead each at a concentration believed to be about 20 ppm were then added, at which point a chemical reaction began and the bubbling of gases was evident at ambient temperature. The production of gas accelerated when the solution was heated to a temperature of 65° C. The product gas was captured in soap bubbles and the bubbles were then ignited. The observed ignition of the gaseous product was typical for a mixture of hydrogen and oxygen.

Since hydrogen gas could only be produced with a concurrent oxidation of iron, it is evident that the iron (III) had to be initially reduced before it could be oxidized, thereby providing strong evidence of the reverse reaction. This experiment has subsequently been repeated with hydrochloric acid (HCl) instead of sulfuric acid, with similar results.

Two additional follow-up experiments (#3 using aluminum metal and #4 using iron metal) were conducted to determine if more hydrogen is produced compared to the maximum amount expected solely from the consumption of the metal. These results are described below.

Experiment #3 Summary:

The starting solution had a total volume of 250 mL, including water, about 50 mL of colloidal magnesium and 80 mL of colloidal lead, each at a concentration believed to be about 20 ppm, 10 mL of 93% concentration H₂SO₄ and 30 mL of 35% concentration HCl as in experiment #1 above. Ten grams of aluminum metal was added to the solution which was heated and maintained at 90° C. The reaction ran for 1.5 hours and yielded 12 liters of gas. The pH was found to have a value under 2.0 at the end of 1.5 hours. The reaction was stopped after 1.5 hours by removing the unused metal and weighing it. The non-consumed aluminum weighed 4.5 grams, indicating a consumption of 5.5 grams of aluminum. The maximum amount of hydrogen gas normally expected by the net consumption of 5.5 grams of aluminum is 6.8 liters, as indicated in the table below.

TABLE 2
Starting Solution Maximum H₂ Yield
With Aluminum Consumption

| | Total Grams | Total Grams | Grams | Maximum |
|---|---|---|---|---|
| Metal | Initial Supply | Final | Consumed | Yield* of H₂ |
| Aluminum | 10 | 4.5 | 5.5 | 6.84 liters |
| (Al) | | | | |

*If reacted aluminum has exclusively been used for the production of hydrogen:
2 moles Al yields 3 moles H₂ (67.2 liters)
2 moles Al = 54 grams

Therefore, a theoretical maximum yield of 1.24 liters of H₂ per gram of Al is expected without the regeneration reaction described above.

As in experiment #1, based on the total amount of acid supplied, it is expected that the first 8.06 liters of the gas generated is pure hydrogen with the balance being 50% hydrogen. Alternatively, the theoretical amount of hydrogen based on the amount of aluminum consumed is 6.84 liters. After 6.84 liters (the maximum yield expected from the aluminum consumed), it is expected that the remaining gas is 66.7% hydrogen. Therefore, we estimate that about 10.3 liters of hydrogen (out of about 12 total liters of gas) was produced in this experiment compared to the maximum of 6.84 or 8.06 liters expected based on the amount of aluminum consumed and the amount of acid supplied, respectively, thereby providing additional evidence of the regeneration process.

Experiment #4 Summary:

The starting solution included a total volume of 250 mL, including water, about 50 mL of colloidal magnesium and 80 mL of colloidal lead, each at a concentration believed to be about 20 ppm, 10 mL of 93% concentration H₂SO₄ and 30 mL of 35% concentration HCl, as in experiment #1 above. One hundred grams of iron pellets (sponge iron) was added to the solution, which was heated and maintained at 90° C. The reaction ran for 30 hours and yielded 15 liters of gas. The pH was found to have a value of about 5.0 at the end of 30 hours. The reaction was stopped after 30 hours by removing the unused metal and weighing it. The non-consumed iron weighed 94 grams, indicating a consumption of 6 grams of iron. The maximum amount of hydrogen gas normally expected by the net consumption of 6 grams of iron, without the regeneration reaction described above, is 2.41 liters, as indicated in the table below.

TABLE 3
Starting Solution Maximum H₂ Yield With Iron Consumption

| | Total Grams | Total Grams | Grams | Maximum |
|---|---|---|---|---|
| Metal | Initial Supply | Final | Consumed | Yield* of H₂ |
| Iron | 100 | 94 | 6 | 2.41 liters |
| (Fe) | | | | |

*If reacted iron has exclusively been used for the production of hydrogen:
1 mole Fe yields 1 mole H₂ (22.4 liters)
1 mole Fe = 55.85 grams

Therefore, a theoretical maximum yield of 0.40 liters of H₂ per gram of Fe is expected without the regeneration reaction described above.

As in experiment #1, based on the total amount of acid supplied, it is expected that the first 8.06 liters of the gas generated is pure hydrogen with the balance being 66.7% hydrogen. However, the maximum theoretical generation of hydrogen based on the amount of iron consumed is 2.41 liters. After 2.41 liters (the maximum yield expected from the iron consumed), it is expected that the remaining gas is 66.7% hydrogen. Therefore, it is estimated that about 10.8 liters of hydrogen (out of about 15 total liters of gas) was produced in this experiment using colloidal catalyst, well over the maximum of 2.41 liters expected with the amount of iron consumed, thereby providing additional evidence of the regeneration process.

Experiment #5 Summary:

An experiment was conducted using 200 mL of the final solution obtained from experiment #4, which contained oxidized iron plus catalyst and was found to have a pH of about 5. Acid was added to the solution, as in the above reactions (10 mL of 93% concentration H₂SO₄ and 30 mL of 35% concentration HCl), that brought the pH to a level of about 1. No additional colloidal materials were added, but 20 grams of aluminum metal was added. The solution was heated to a constant 96° C. The reaction proceeded to produce 32 liters of gas in a span of 18 hours, at which point the rate of the reaction had slowed significantly and the pH of the solution had become approximately 5.

The metal remaining at the end of the 18-hour experiment was separated and found to have a mass of 9 grams. This metal appeared to be a mixture of Al and Fe. Therefore, neglecting the amount of iron and aluminum remaining in solution, there was net consumption of 11 grams of metal and a net production of 32 liters of gas.

As indicated above, based on the amount of acid added to the reaction, the maximum amount of hydrogen gas expected solely from the reaction of acid with metal would be 8.06 liters. Depending on the makeup of the recovered metal, which had a mass of 9 grams, two extremes are possible: a) assuming the metal recovered was 100% Al, a maximum of 13.75 liters of hydrogen gas would be expected from the consumption of 11 grams of aluminum; and b) alternatively, assuming the metal recovered was 100% Fe, a maximum of 21.25 liters of hydrogen gas would be expected from the consumption of 17 grams of aluminum (20 grams supplied minus three grams used in the production of iron). For purposes of calculating maximum hydrogen gas generation, we assume the regeneration process does not occur and the Fe metal would have been generated from a conventional single displacement reaction with Al.

The actual percentage of Al and Fe would be somewhere between the two extremes and, therefore, the maximum amount of hydrogen gas generated solely from the consumption of metal (without regeneration) would be between 13.75 liters and 21.25 liters. The observed generation of 32 liters of gas compared to the maximum amount one would expect from the sole consumption of metal indicates that the regeneration process is taking place. It is believed that the increase in the rate of H₂ production resulted from a high concentration of metal ions in the solution prior to the introduction of the elemental iron. Thus, resulting solutions from this family of reactions should not be discarded but rather should be used as the starting point for subsequent reactions. Consequently, this process for the generation of H₂ will not produce significant chemical wastes that need to be disposed of.

Experiment #6 Summary:

An experiment was conducted using 20 mL FeCl₃, 10 mL colloidal magnesium, and 20 mL colloidal lead at a temperature of about 90° C. A gas was produced that is believed to be a mixture of hydrogen and oxygen, based upon observing the ignition of the gas. The pH of the mixture decreased during the reaction from a value of about 4.5 to a value of about 3.5. These observations show that it is not necessary to introduce either metallic iron or acid into the solution to produce hydrogen. Since the electrochemical oxidation/reduction reactions (equations 21-23 resulting in the net equation 24) result in the production of metallic iron and acid, these two constituents can be produced in this manner. Presumably, this would eventually attain the same steady state that is reached when metallic iron and acid are supplied initially.

Experiment #7 Summary

An initial solution comprising 10 mL of 93% concentration H₂SO₄ and 30 mL of 35% concentration HCl was reacted with 20 grams of iron pellets, and 20 grams of aluminum pellets. There were then added 50 mL of colloidal magnesium and 80 mL of colloidal lead each at a concentration believed to be about 20 ppm, producing a total volume of about 215 mL. A theoretical maximum of 8.06 liters of hydrogen gas could be produced if solely from the consumption of the acids as indicated in Table 4.

TABLE 4
Starting Solution Maximum H₂ Yield with Acid Consumption

| | | | | Effective | |
|---|---|---|---|---|---|
| | | | Total | Grams of | Maximum H₂ |
| Acid | mL | Concentration | Grams | Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)
1 mole H₂SO₄ = 98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The experimental setup was as illustrated in FIG. 2. The mixture of acids and metals was placed in flask 202. A hot plate 204 was used to provide thermal energy for the reaction and maintain the solution at a temperature of about 71° C. The gas produced by the reaction was fed through tube 206 to a volume-measuring apparatus 208. The volume-measuring apparatus 208 was an inverted reaction vessel 210 filled with water and placed in a water bath 212. The primary purpose of the experiment was to provide evidence that more than the theoretical maximum 8.06 liters of hydrogen was being produced by the closed-loop process of the invention.

The rate of the reaction initially is very fast with instantaneous hydrogen generation at a rate of about 20 liters per hour. After about an hour the rate slows to a steady-state value of about 8.4 liters of gas produced per hour. Heat may be added to the process to accelerate the process of regenerating the metals and the acids.

While some gas was lost due to leakage and diffusion, at least 25 liters of gas was collected over a period of three hours, and the reaction was still proceeding in a continuous fashion at a rate of 8.4 liters of gas produced per hour. At this point the experiment was stopped and the remaining metal, a mixture of aluminum and iron was collected and dried, and was found to have a mass of 35.5 grams. Thus, 4.5 grams of metal was consumed. Since the remaining metal was not analyzed, it is not known in what ratio aluminum and iron reacted; however the simple oxidation of a metal by an acid would produce a maximum of 5.6 liters of hydrogen, well below that observed. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides ample evidence for the regeneration process.

It is believed that the simultaneous use of two metals does not improve the initial rate of gas formation, but rather produces a reaction rate that is sustained over a much greater period of time. In order to further demonstrate this point, two additional experiments were performed.

Experiment #8 Summary:

An initial solution comprising 10 mL of 93% concentration H₂SO₄ and 30 mL of 35% concentration HCl was reacted with 20 grams of aluminum pellets. There were then added 50 mL of colloidal magnesium and 80 mL of colloidal lead each at a concentration believed to be about 20 ppm, producing a total volume of about 215 mL. A theoretical maximum of 8.06 liters of hydrogen gas could be produced if solely from the consumption of the acids as indicated in Table 5.

TABLE 5
Starting Solution Maximum H₂ Yield with Acid Consumption

| | | | | Effective | |
|---|---|---|---|---|---|
| | | | Total | Grams of | Maximum H₂ |
| Acid | mL | Concentration | Grams | Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)
1 mole H₂SO₄ = 98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The experimental setup was as illustrated in FIG. 2. The mixture of acids and metal was placed in flask 202. A hot plate 204 was used to provide thermal energy for the reaction and maintain the solution at a temperature of about 71° C. The gas produced by the reaction was fed through tube 206 to a volume-measuring apparatus 208. The volume-measuring apparatus 208 was an inverted reaction vessel 210 filled with water and placed in a water bath 212. The primary purpose of the experiment was to provide evidence that more than the theoretical maximum 8.06 liters of hydrogen was being produced by the closed-loop process of the invention.

The initial reaction rate was similar to that found in experiment #1, where 9 liters of gas was produced in slightly less than one hour. At this point, however, the reaction rate was found to decrease by a factor of approximately one half. The addition of 20 grams of iron caused an immediate increase in reaction rate to the value that was initially observed at the onset of the experiment.

Experiment #9 Summary:

An initial solution comprising 10 mL of 93% concentration H₂SO₄ and 30 mL of 35% concentration HCl was reacted with 40 grams of aluminum pellets. There were then added 50 mL of colloidal magnesium and 80 mL of colloidal lead each at a concentration believed to be about 20 ppm, producing a total volume of about 215 mL. A theoretical maximum of 8.06 liters of hydrogen gas could be produced if solely from the consumption of the acids as indicated in Table 6.

TABLE 6
Starting Solution Maximum H₂ Yield with Acid Consumption

| | | | | Effective | |
|---|---|---|---|---|---|
| | | | Total | Grams of | Maximum H₂ |
| Acid | mL | Concentration | Grams | Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)
1 mole H₂SO₄ = 98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The experimental setup was as illustrated in FIG. 2. The mixture of acids and metal was placed in flask 202. A hot plate 204 was used to provide thermal energy for the reaction and maintain the solution at a temperature of about 71° C. The gas produced by the reaction was fed through tube 206 to a volume-measuring apparatus 208. The volume-measuring apparatus 208 was an inverted reaction vessel 210 filled with water and placed in a water bath 212. The primary purpose of the experiment was to provide evidence that more than the theoretical maximum 8.06 liters of hydrogen was being produced by the closed-loop process of the invention.

The initial reaction rate was similar to that found in experiment #1, where 9 liters of gas was produced in slightly less than one hour. At this point however the reaction rate was found to decrease by a factor of approximately one half. The addition of 20 grams of iron caused an immediate increase in reaction rate to the value that was observed at the onset of the experiment.

Clearly an interaction is taking place between the two metals that produces a reaction that sustains its high rate of gas production a significant period of time.

Experiment #10 Summary:

An initial solution comprising 10 mL of 93% concentration H₂SO₄ and 30 mL of 35% concentration HCl was reacted with 20 grams of iron pellets, and 20 grams of aluminum pellets. There were then added 25 mL of colloidal magnesium and 40 mL of colloidal lead each at a concentration believed to be about 20 ppm, producing a total volume of about 110 mL. A theoretical maximum of 8.06 liters of hydrogen gas could be produced if solely from the consumption of the acids as indicated in Table 7.

TABLE 7
Starting Solution Maximum H₂ Yield with Acid Consumption

| | | | | Effective | |
|---|---|---|---|---|---|
| | | | Total | Grams of | Maximum H₂ |
| Acid | mL | Concentration | Grams | Acid | Yield |
| H₂SO₄ | 10 | 93.0% | 18.97 | 17.64 | 4.03 liters |
| HCl | 30 | 35.0% | 37.52 | 13.13 | 4.03 liters |

| | |
|---|---|
| Maximum H₂ Yield: | 8.06 liters |

1 mole H₂SO₄ yields 1 mole of H₂ (22.4 liters @ STP)
1 mole H₂SO₄ = 98 grams

Therefore, a theoretical maximum yield of 0.23 liters of H₂ per gram of H₂SO₄ is expected without the regeneration reaction.

2 moles of HCl yields 1 mole of H₂ (22.4 liters @ STP)

2 moles of HCl=73 grams

Therefore, a theoretical maximum yield of 0.31 liters of H₂ per gram of HCl is expected without the regeneration reaction.

The experimental setup was as illustrated in FIG. 2. The mixture of acids and metals was placed in flask 202. A hot plate 204 was used to provide thermal energy for the reaction and maintain the solution at a temperature of about 90° C. The gas produced by the reaction was fed through tube 206 to a volume-measuring apparatus 208. The volume-measuring apparatus 208 was an inverted reaction vessel 210 filled with water and placed in a water bath 212. The primary purpose of the experiment was to provide evidence that more than the theoretical maximum 8.06 liters of hydrogen was being produced by the closed-loop process of the invention.

The rate of the reaction initially is very fast with instantaneous hydrogen generation at a rate of about 20 liters per hour. After about an hour the rate slows to a steady-state value of about 6.0 liters per hour. Additional heat may be added to the process to further accelerate the process of regenerating the metals and the acids.

While some gas was lost due to leakage and diffusion, at least 32 liters of gas was collected over a period of five hours, and the reaction was still proceeding in a continuous fashion at a rate of 6.0 liters per hour. At this point, the experiment was stopped and the remaining metal, a mixture of aluminum and iron was collected and dried, and was found to have a mass of about 40 grams. Thus, only a negligible amount of metal was consumed. Since the remaining metal was not analyzed, it is not known in what ratio aluminum and iron were present; however, it can be assumed that approximately 20 grams of each metal was present in the remaining metallic sample. Based upon previous observations and theoretical projections, the first 8.06 liters of gas produced is likely to be made up of essentially pure hydrogen, and beyond the theoretical threshold of 8.06 liters, 66.7% by volume of the gas produced would be hydrogen and the other 33.3% by volume would be oxygen. It is believed this experiment provides further evidence for a more efficient regeneration process when smaller volumes are used in the reaction vessel.

The foregoing experiments were carried out under ambient lighting conditions which included a mixture of artificial and natural light sources. When the reactions described were performed under decreased light conditions, the reaction rates decreased. However, separate formal testing under decreased lighting has not been performed.

It is believed the experimental results described above demonstrate the potential value of the invention described herein. However, the calculations are based on the reaction mechanisms described above and are believed to accurately characterize the reactions involved in these experiments. However, if it is discovered that the theories of reactions or the calculations based thereon are in error, the invention described herein nevertheless is valid and valuable.

The embodiments shown and described above are exemplary. Many details are often found in the art and, therefore, many such details are neither shown nor described. It is not claimed that all of the details, parts, elements, or steps described and shown were invented herein. Even though numerous characteristics and advantages of the present invention have been described in the drawings and accompanying text, the description is illustrative only, and changes may be made in the detail, especially in matters of shape, size, and arrangement of the parts within the principles of the inventions to the full extent indicated by the broad meaning of the terms of the attached claims.

The restrictive description and drawings of the specific examples above do not point out what an infringement of this patent would be, but are to provide at least one explanation of how to use and make the inventions. The limits of the invention and the bounds of the patent protection are measured by and defined in the following claims.

1. An apparatus for the production of hydrogen, comprising:
a reaction medium with a pH less than 7;
a first metal, wherein the first metal is a colloidal metal suspended in the reaction medium; and
a second metal, wherein the second metal is in contact with the reaction medium.

2. The apparatus of claim 1, wherein the second metal is in solid, non-colloidal form.

3. The apparatus of claim 1, wherein the first metal is less reactive than the second metal.

4. The apparatus of claim 1, wherein the first metal is more reactive than the second metal.

5. The apparatus of claim 1 further comprising a third metal in contact with the reaction medium.

6. The apparatus of claim 5, wherein the third metal is in colloidal form.

7. The apparatus of claim 6, wherein the third metal is more reactive than the second metal.

8. The apparatus of claim 1 further comprising a reaction vessel for containing the reaction medium, wherein the reaction vessel is inert to the reaction medium.

9. The apparatus of claim 8, wherein the reaction vessel is configured to maintain an internal pressure above atmospheric pressure.

10. The apparatus of claim 1, wherein the first metal is silver, gold, platinum, tin, lead, copper, zinc, iron, aluminum, magnesium, beryllium, nickel or cadmium.

11. The apparatus of claim 1, wherein the second metal is iron, aluminum, magnesium, beryllium, tin, lead, nickel or copper.

12. The apparatus of claim 6, wherein the third metal is aluminum, magnesium, beryllium or lithium.

13. The apparatus of claim 1, wherein the reaction medium comprises hydrogen peroxide.

14. The apparatus of claim 1, wherein the reaction medium comprises formic acid.

15. The apparatus of claim 1 further comprising an elemental nonmetal in contact with the reaction medium.

16. The apparatus of claim 1 further comprising an energy source.

17. The apparatus of claim 16, wherein the energy source is a heater.

18. The apparatus of claim 16, wherein the energy source is a light source.

19. The apparatus of claim 16, wherein the energy source is an electrical potential applied to the reaction medium.

20. The apparatus of claim 1 further comprising an anode and a cathode, wherein the anode and cathode are in contact with the reaction medium and wherein an electrical potential is applied between the anode and cathode.

21. The apparatus of claim 1 further comprising third and fourth metals, wherein at least one of the second, third or fourth metals is in colloidal form.

22. A method for the production of hydrogen, comprising the steps of:
suspending a first metal in a reaction medium with a pH less than 7, wherein the first metal is a colloidal metal; and
providing a second metal in contact with the reaction medium.

23. The method of claim 22 further comprising the step of providing a third metal in contact with the reaction medium.

24. The method of claim 23, wherein the third metal is a colloidal metal suspended in the reaction medium.

25. The method of claim 22, wherein the reaction medium is in a reaction vessel, wherein the reaction vessel is inert to the reaction medium.

26. The method of claim 22 further comprising the step of providing an elemental nonmetal in contact with the reaction medium.

27. The method of claim 22 further comprising the step of supplying energy to the reaction medium.

28. The method of claim 22 further comprising the step of providing a cathode and an anode in contact with the reaction medium and providing an electrical potential between the anode and the cathode.

29. The method of claim 22 further comprising the step of providing third and fourth metals in contact with the reaction medium, wherein at least one of the second, third or fourth metals is in colloidal form.

30. The method of claim 22 further comprising the step of producing oxygen gas.

31. The method of claim 22 further comprising both oxidation and reduction of the second metal.

32. An apparatus for the production of hydrogen, comprising:
a reaction medium containing an acid;
a first colloidal metal suspended in the reaction medium; and
a second metal, wherein the second metal is in contact with the reaction medium.

33. The apparatus of claim 32, wherein the acid is sulfuric acid, hydrochloric acid, hydrobromic acid, nitric acid, hydroiodic acid, perchloric acid or chloric acid.

34. The apparatus of claim 32 further comprising a third metal in contact with the reaction medium.

35. The apparatus of claim 34, wherein the third metal is a colloidal metal suspended in the solution.

36. An apparatus for the production of hydrogen, comprising:
a reaction medium with a pH less than 7;
a first metal in contact with the reaction medium, the first metal having a surface area of at least 298,000,000 m² per cubic meter of first metal; and
a second metal in contact with the reaction medium.

37. The apparatus of claim 32 further comprising a third metal in contact with the reaction medium.

38. The apparatus of claim 37, wherein the third metal has a surface area of at least 298,000,000 m² per cubic meter of third metal.

39. The apparatus of claim 38, further comprising a fourth metal.

40. An apparatus for the production of hydrogen, comprising:
a reaction medium with a pH less than 7, wherein the reaction medium contains cations of a first metal; and
a first colloidal metal suspended in the reaction medium.

41. The apparatus of claim 40 further comprising a second colloidal metal suspended in the reaction medium.

42. The apparatus of claim 40, wherein the reaction medium further contains cations of a second metal.

43. An apparatus for the production of hydrogen, comprising:
a reaction medium with a pH less than 7;
a first colloidal metal suspended in the reaction medium; and
an ionic metal.

44. The apparatus of claim 43 further comprising a second colloidal metal suspended in the reaction medium.

45. The apparatus of claim 43 further comprising a solid metal in contact with the reaction medium.

46. The apparatus of claim 43 further comprising a second ionic metal.

47. A method for the production of hydrogen, comprising the steps of:
suspending a colloidal metal in a reaction medium with a pH less than 7; and
introducing an ionic metal into the reaction medium.

48. The method of claim 47 further comprising the step of reducing the ionic metal to produce a solid metal.

49. A mixture for the production of hydrogen, comprising:
a reaction medium;
a first colloidal metal suspended in the reaction medium; and
a salt dissolved in the reaction medium.

50. The mixture of claim 49 further comprising a second metal in contact with the reaction medium.

51. A method for the production of hydrogen, comprising the steps of:
suspending a first colloidal metal in a reaction medium; and
dissolving a salt in the reaction medium.

52. The method of claim 49 further comprising the step of providing a second metal in contact with the reaction medium.

53. An apparatus for the production of hydrogen, comprising:
a reaction vessel configured to maintain an internal pressure greater than atmospheric pressure;
an acidic solution in the reaction vessel;
at least two metals in solid form in contact with the acidic solution;
at least two colloidal metals suspended in the acidic solution, wherein one of the colloidal metals is more reactive than the solid metals and the other colloidal metal is less reactive than the solid metals;
an elemental nonmetal in contact with the acidic solution; and
a heater configured to provide thermal energy to the acidic solution.

54. A mixture for the production of hydrogen, comprising:
a reaction medium with a pH less than 7;
a first colloidal metal suspended in the reaction medium; and
a second metal, wherein the second metal is in contact with the reaction medium.

55. The mixture of claim 54 further comprising a third metal in contact with the reaction medium.

56. The mixture of claim 55, wherein the third metal is in colloidal form.

57. The mixture of claim 54 further comprising an elemental nonmetal in contact with the reaction medium.

58. The mixture of claim 54 further comprising third and fourth metals, wherein at least one of the second, third or fourth metals is in colloidal form.
